(19) United States
(12) Patent Application Publication
(10) Pub. No.: US 2024/0343285 A1
(43) Pub. Date: Oct. 17, 2024

(54) FOLDABLE ALL TERRAIN VEHICLE

(71) Applicant: AnHui HanTang Leisure Products Co.,LTD., Suzhou City (CN)

(72) Inventors: Chongxin Yang, Suzhou City (CN); Liang Lv, Suzhou City (CN); Kaizhu Zhang, Suzhou City (CN); Lei Yang, Suzhou City (CN)

(73) Assignee: AnHui HanTang Leisure Products Co.,LTD., Suzhou City (CN)

(21) Appl. No.: 18/635,330

(22) Filed: Apr. 15, 2024

(30) Foreign Application Priority Data
Apr. 15, 2023 (CN) 202320888683.3
Dec. 20, 2023 (CN) 202323478870.3

(51) Int. Cl. B62B 3/02; B62B 5/06

(52) U.S. Cl. CPC B62B 3/02; B62B 5/06; B62B 2205/06; B62B 2205/20

(57) ABSTRACT

A foldable all terrain vehicle is provided. The foldable all terrain vehicle includes a base support, the base support includes four bottom rods and an eighth connector. One end of each of the bottom rods is rotatably connected with the eighth connector. The bottom rods rotate downwards relative to the eighth connector. Seventh connectors are movably connected to outer ends of two bottom rods of the bottom rods. First connectors are movably connected to outer ends of another two bottom rods of the bottom rods. Movable wheels are mounted at bottoms of the first connectors. X-shaped movable frames are connected to one sides of the seventh connectors. Upright rods are mounted on tops of the seventh connectors. Fifth connecting rods are rotatably mounted at another sides of the seventh connectors. X-shaped movable frames are slidably connected to the fifth connecting rods through sixth connectors.

### CROSS-REFERENCE TO RELATED APPLICATION

This patent application claims the benefits and priorities of Chinese Patent Application No. 2023208886833 filed with the China National Intellectual Property Administration on Apr. 15, 2023, and Chinese Patent Application No. 2023234788703 filed with the China National Intellectual Property Administration on Dec. 20, 2023, the disclosures of which are incorporated by reference herein in their entirety as part of the present application.

### TECHNICAL FIELD

The present disclosure relates to the technical field of all terrain vehicles, in particular to a foldable all terrain vehicle.

### BACKGROUND

Foldable all terrain vehicles, as foldable conveying tools for conveying articles, can travel on roads with poor road conditions, such as beaches and gravel roads. Foldable all terrain vehicles not only have high transportation stability, but also can be folded, so that they are more convenient to use. However, in order to facilitate folding, all terrain vehicles in the prior art have limited storage space, and an increasing of the storage space will increase the space occupied when folded.

### SUMMARY

The purpose of the present disclosure is to provide a foldable all terrain vehicle so as to solve the problems in the prior art. The space occupied when folded is reduced while the storage space is increased.

In order to achieve the above-mentioned purposes, the present disclosure provides the following solution. A foldable all terrain vehicle provided by the present disclosure includes a base support, the base support includes four bottom rods and an eighth connector. One end of each of the bottom rods is rotatably connected with the eighth connector. The bottom rods rotate downwards relative to the eighth connector. Seventh connectors are movably connected to outer ends of two bottom rods of the bottom rods. First connectors are movably connected to outer ends of another two bottom rods of the bottom rods. Movable wheels are mounted at bottoms of the first connectors. X-shaped movable frames are connected to one sides of the seventh connectors. Upright rods are mounted on tops of the seventh connectors. Fifth connecting rods are rotatably mounted at another sides of the seventh connectors. X-shaped movable frames are slidably connected to the fifth connecting rods through sixth connectors.

Preferably, each of the X-shaped movable frames includes two fourth connecting rods that are rotatably connected to each other, and bottom ends of the fourth connecting rods are rotatably connected with the seventh connectors.

Preferably, fourth connectors are mounted on tops of the upright rods. Third connecting rods are rotatably connected to top ends of the fourth connecting rods through fifth connectors. The third connecting rods are rotatably connected with the fourth connectors. Top ends of the X-shaped movable frames are movably connected with the third connecting rods through the fifth connectors.

Preferably, two opposite third connecting rods in the third connecting rods are same in length.

Preferably, second connectors are movably mounted on tops of the first connectors, and first connecting rods are rotatably connected to the second connectors; and the X-shaped movable frames are arranged between two first connectors in the first connectors.

Preferably, a rotatable third connector is connected to top ends of two first connecting rods in the first connecting rods, a second connecting rod is inserted and connected to the third connector, and a handle is mounted on a top of the second connecting rod.

Preferably, anti-skid grooves are formed in wheel surfaces of the movable wheels.

Preferably, the eighth connector is in an X-shape, and four ends of the eighth connector are rotatably connected with one ends of the bottom rods through screws, respectively.

Preferably, bottom ends of the second connectors are rotatably connected with the first connectors, and notches for placing rotating cylinders of the second connectors are formed in the first connectors.

Preferably, the fourth connecting rods and the third connecting rods are connected through the fifth connectors, and each of the fifth connectors includes two sleeves that are rotatably connected to each other.

Further, a foldable all terrain vehicle including a plurality of upright rods is provided by the present disclosure. Number of the upright rods is four. The upright rods are divided into groups, each group is consisted of two upright rods. First connectors are mounted at bottoms of two upright rods. Seventh connectors are mounted at bottoms of another two upright rods. Bottom rods are rotatably mounted on both the first connectors and the seventh connectors. An eighth connector is rotatably connected to one end of each of the bottom rods. Fourth connectors are rotatably mounted on tops of the upright rods. Sixth connecting rods are rotatably mounted at one ends of the fourth connectors. Third connecting rods are rotatably mounted at another ends of the fourth connecting rods. Fourth connecting rods are rotatably mounted on the third connecting rods. One ends of the fourth connecting rods are rotatably connected with the first connectors or the seventh connectors. Every two adjacent fourth connecting rods are crossed and rotatably connected to each other. First crosses are mounted on the sixth connecting rods. Every two adjacent first crosses are connected through a second cross. Second connectors are rotatably mounted on the first connectors. First connecting rods are rotatably mounted on the second connectors. A third connector is rotatably connected to one ends of the first connecting rods. Each of the first crosses includes a third diagonal rod and a second diagonal rod. The third diagonal rod is rotatably connected with the second diagonal rod. One end of the third diagonal rod is rotatably connected with one of the sixth connecting rods. Another end of the third diagonal rod is rotatably connected with one end of the third diagonal rod of another first cross in the first crosses. One end of the second diagonal rod of a first cross in the first crosses are rotatably connected with one of the first connector. One end of the second diagonal rod of another first cross in the first crosses is rotatably connected with one of the seventh connectors. Each of the second crosses includes two first diagonal rods that are crossed and rotatably connected to each other. One end of each of the first diagonal rods is rotatably connected with one end of the second diagonal rod, and another end of each of the first diagonal rods is rotatably connected with the third diagonal rod.

Preferably, mounting blocks are slidably mounted on the fourth connectors, and connecting slots are formed in both sides of each of the mounting blocks.

Preferably, sliding blocks are mounted on the fourth connectors, and sliding grooves matched with the sliding blocks are formed in the mounting blocks.

Preferably, number of the connecting slots is two, and the two connecting slots are symmetrically formed in both sides of each of the mounting blocks.

Preferably, the foldable all terrain vehicle further includes movable wheels. Insertion rods are mounted on the movable wheels. Latch mechanisms are mounted on the insertion rods. Slots matched with the insertion rods are formed in the upright rods.

Preferably, each of the latch mechanisms includes a spring, a connecting plate, and a locking block. A sliding cavity adapted to the connecting plate is formed in each of the insertion rods. The locking block is mounted at one end of the connecting plate. The spring is arranged at another end of the connecting plate. A locking hole adapted to the locking block is formed in each of the upright rods. A mounting hole adapted to the spring is formed in each of the upright rods.

Preferably, the locking hole is formed in one side of each of the upright rods. The mounting hole is formed in another side of each of the upright rods. The mounting hole is located below the locking hole.

Preferably, a handle is mounted on the third connector.

Compared with the prior art, the present disclosure achieves the following technical effects.

According to the foldable all terrain vehicle in the present disclosure, by arranging the eighth connector, moving stability of the all terrain vehicle can be improved, and the eighth connector is stable when being connected to the bottom rods. By arranging the X-shaped or crossed movable frames connected to the fifth connecting rods, a length of connection between a frame and a cloth pocket of the all terrain vehicle can be effectively increased, and stability and storage capacity of the all terrain vehicle are improved. Moreover, the storage space when folded can also be effectively reduced, so that the all terrain vehicle is more convenient to use.

### BRIEF DESCRIPTION OF THE DRAWINGS

To more clearly illustrate the present embodiments of the present disclosure or the technical solution in the prior art, the following briefly introduces the attached figures to be used in the present embodiment. Apparently, the attached figures in the following description show merely some embodiments of the present disclosure, and those skilled in the art may still derive other figures from these attached figures without creative efforts.

FIG. 1 is a diagram of an unfolded entire structure of a foldable all terrain vehicle according to a first embodiment of the present disclosure;

FIG. 2 is a diagram of a folded entire structure of a foldable all terrain vehicle according to a first embodiment of the present disclosure;

FIG. 3 is a schematic diagram of a connection structure of bottom rods according to a first embodiment of the present disclosure;

FIG. 4 is a structural schematic diagram of a seventh connector according to a first embodiment of the present disclosure;

FIG. 5 is a structural schematic diagram of a sixth connector according to a first embodiment of the present disclosure;

FIG. 6 is a structural schematic diagram of a fourth connector according to a first embodiment of the present disclosure;

FIG. 7 is a structural schematic diagram of a first connector according to a first embodiment of the present disclosure;

FIG. 8 is a structural schematic diagram of a sixth connector according to a first embodiment of the present disclosure;

FIG. 9 is a structural schematic diagram of a second connector according to a first embodiment of the present disclosure;

FIG. 10 is a structural schematic diagram of a fifth connector according to a first embodiment of the present disclosure;

FIG. 11 is a schematic diagram of an entire structure of a foldable all terrain vehicle according to a second embodiment of the present disclosure;

FIG. 12 is a structural schematic diagram of a locking block according to a second embodiment of the present disclosure;

FIG. 13 is a structural schematic diagram of bottom rods according to a second embodiment of the present disclosure;

FIG. 14 is a structural schematic diagram of sixth connecting rods according to a second embodiment of the present disclosure;

FIG. 15 is a structural schematic diagram of an insertion rod according to a second embodiment of the present disclosure;

FIG. 16 is a structural schematic diagram of an upright rod according to a second embodiment of the present disclosure;

FIG. 17 is a structural schematic diagram of a sliding block according to a second embodiment of the present disclosure; and

FIG. 18 is a structural schematic diagram of a mounting block according to a second embodiment of the present disclosure.

### REFERENCE SIGNS IN THE ATTACHED FIGURES

In the first embodiment: 11 movable wheel; 12 first connector; 13 second connector; 14 first connecting rod; 15 third connector; 16 second connecting rod; 17 handle; 18 fourth connector; 19 fifth connector; 110 sixth connector; 111 third connecting rod; 112 fourth connecting rod; 113 upright rod; 114 seventh connector; 115 bottom rod; 116 eighth connector; and 117 fifth connecting rod.

In the second embodiment: 21 upright rod; 22 seventh connector; 23 fourth connector; 24 mounting block; 25 sixth connecting rod; 26 movable wheel; 27 first connector; 28 third connecting rod; 29 fourth connecting rod; 210 second connector; 211 first connecting rod; 212 third connector; 213 handle; 214 bottom rod; 215 eighth connector; 216 insertion rod; 217 locking block; 218 connecting plate; 219 spring; 220 sliding block; 221 connecting slot; 222 first diagonal rod; 223 second diagonal rod; and 224 third diagonal rod.

### DETAILED DESCRIPTION OF THE EMBODIMENTS

The following clearly and completely describes the technical solutions in the embodiments of the present disclosure with reference to the attached figures of the embodiments of the present disclosure. Apparently, the described embodiments are merely a part rather than all of the embodiments of the present disclosure. Based on the embodiments in the present disclosure, all other embodiments obtained by those skilled in the art without creative efforts fall within the scope protected by the present disclosure.

The purpose of the present disclosure is to provide a foldable all terrain vehicle so as to solve the problems in the prior art. The space occupied when folded is reduced while the storage space is increased.

To make the foregoing purpose, features and advantages of the present disclosure clearer and more comprehensible, the present disclosure is further described in detail below with reference to the attached figures and specific embodiments.

### First Embodiment

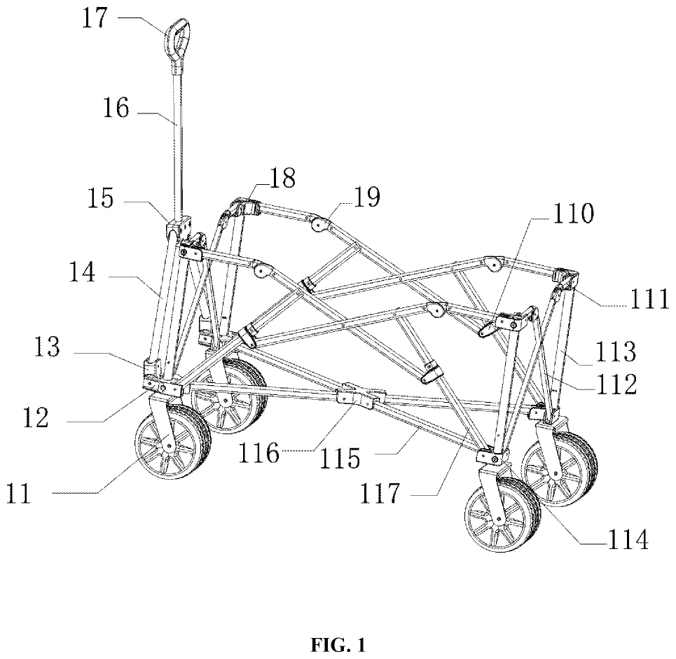

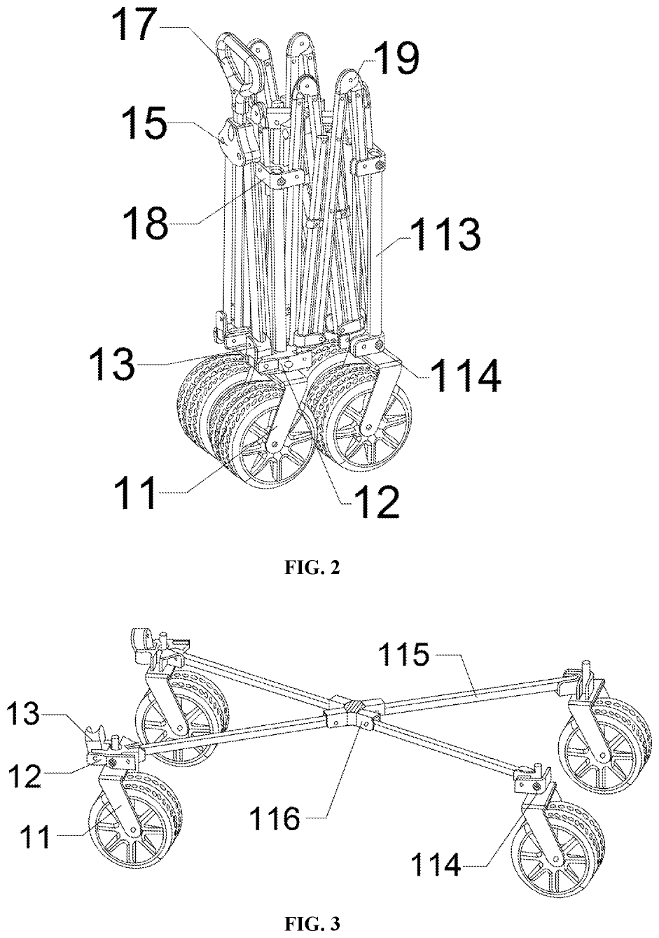

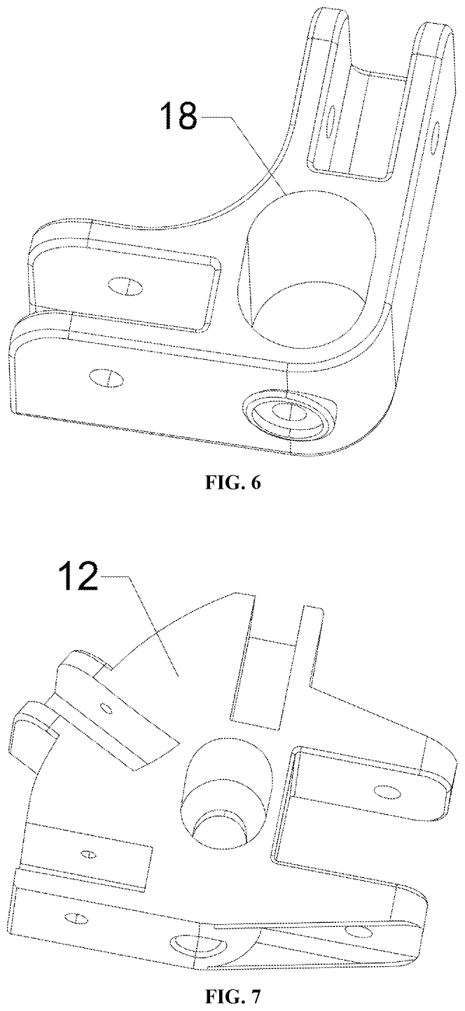

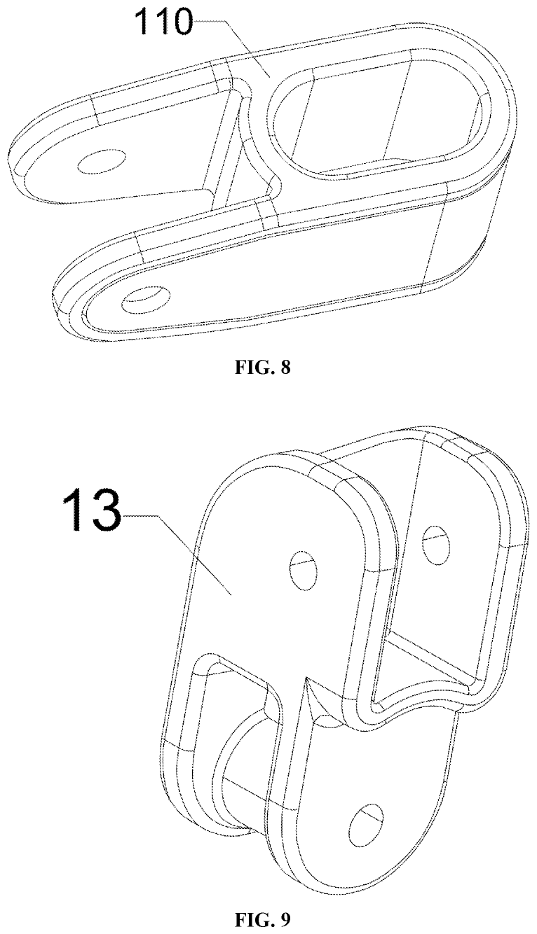

As shown in FIG. 1 to FIG. 10, the foldable all terrain vehicle provided in this embodiment includes a base support, the base support includes four bottom rods 115 and an eighth connector 116. One end of each of the bottom rods 115 is rotatably connected with the eighth connector 116. The bottom rods 115 rotate downwards only with the limitation of the eighth connector 116, so that the four bottom rods 115 are convenient to fold. Seventh connectors 114 are movably connected to outer ends of two of the bottom rods 115, and first connectors 12 are movably connected to outer ends of another two of the bottom rods 115. X-shaped movable frames are connected to one sides of the seventh connectors 114. Each of the X-shaped movable frames includes two fourth connecting rods 112 that are rotatably connected to each other. Bottom ends of the fourth connecting rods 112 are rotatably connected to the seventh connectors 114. Upright rods 113 are mounted on tops of the seventh connectors 114. Fourth connectors 18 are mounted on tops of the upright rods 113. Third connecting rods 111 are rotatably connected to top ends of the fourth connecting rods 112 through fifth connectors 19. The third connecting rods 111 are rotatably connected with the fourth connectors 18. Two opposite third connecting rod in the third connecting rods 111 are the same in length, so that it is more convenient for folding, interference is reduced while the space occupied when folded is reduced. Second connectors 13 are movably mounted on tops of the first connectors 12, and first connecting rods 14 are rotatably connected to the second connectors 13. X-shaped movable frames are arranged between two first connectors of the first connectors 12 and used for providing support while connecting the two first connectors 12. A rotatable third connector 15 is connected to top ends of the two first connecting rods 14, a second connecting rod 16 is inserted and connected to the third connector 15, and a handle 17 is mounted on a top of the second connecting rod 16. Movable wheels 11 are mounted at bottoms of the first connectors 12. Anti-skid grooves are formed in wheel surfaces of the movable wheels 11, which provide a better grip when travelling on beaches, and the foldable all terrain vehicle is more stable during driving.

Fifth connecting rods 117 are rotatably mounted on another sides of the seventh connectors 114, and X-shaped movable frames are slidably connected to the fifth connecting rods 117 through sixth connectors 110. Top ends of the X-shaped movable frames are movably connected with the third connecting rods 111 through the fifth connectors 19. The fifth connecting rods 117 are movably connected with the X-shaped movable frames, so that the storage capacity of the all terrain vehicle can be effectively improved. Moreover, the space occupied when folded can also be effectively reduced, so that the foldable all terrain vehicle is more convenient to carry and use.

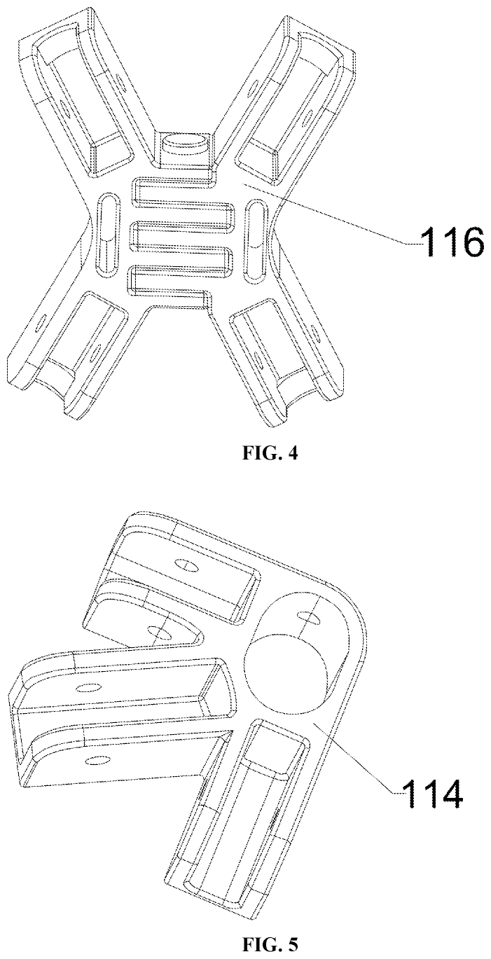

In this embodiment, as shown in FIG. 3 and FIG. 4, the eighth connector 116 for connecting the bottom rods 115 is in an X-shape, and four ends of the eighth connector 116 are\rotatably connected with one ends of the bottom rods 115 through screws, respectively. Because top of the eighth connector 116 is closed, the bottom rods 115 can only rotate downwards when rotating. When being leveled, the eighth connector 116 can provide a high supporting force, and can provide stable support for the whole all terrain vehicle. Moreover, the surface of the all terrain vehicle is more flat when unfolded.

In this embodiment, as shown in FIG. 7 and FIG. 9, bottom ends of the second connectors 13 are rotatably connected with the first connectors 12, and notches for placing rotating cylinders of the second connectors 13 are formed in the first connectors 12, the notches and the rotating cylinders are connected through screws during installation. Meanwhile, the first connecting rods 14 are connected with the third connector 15, so that the folding direction of the first connecting rods 14 can be adjusted from multiple angles, and folding is more convenient and simple.

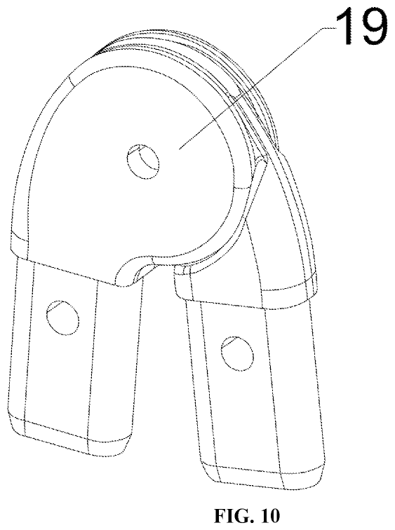

In this embodiment, as shown in FIG. 10, the fourth connecting rods 112 and the third connecting rods 111 are connected through the fifth connectors 19, and each of the fifth connectors 19 includes two sleeves that are rotatably connected to each other. Top connection ports of the fourth connecting rods 112 and the third connecting rods 111 are located at an upper part of the all terrain vehicle, so that safety during use can be effectively improved. Ports of the fourth connecting rods 112 and the third connecting rods 111 are covered, so that damage to the ports of the fourth connecting rods 112 and the third connecting rods 111 is reduced, and safety is improved. Other related connectors also have the protective performance, so that safety is improved.

In conclusion, in the foldable all terrain vehicle according to this embodiment, by arranging the eighth connector 116, moving stability of the all terrain vehicle can be improved, and the eighth connector 116 is stable when being connected to the bottom rods 115. By arranging the X-shaped movable frames connected to the fifth connecting rods 117, a length of the all terrain vehicle can be effectively increased, and storage capacity is improved. Moreover, the storage space when folded can also be effectively reduced, so that the all terrain vehicle is more convenient to use.

### Second Embodiment

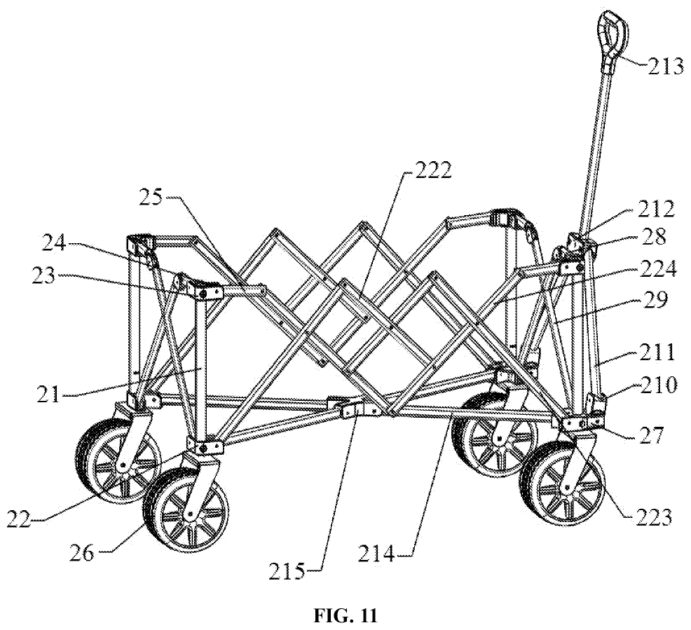

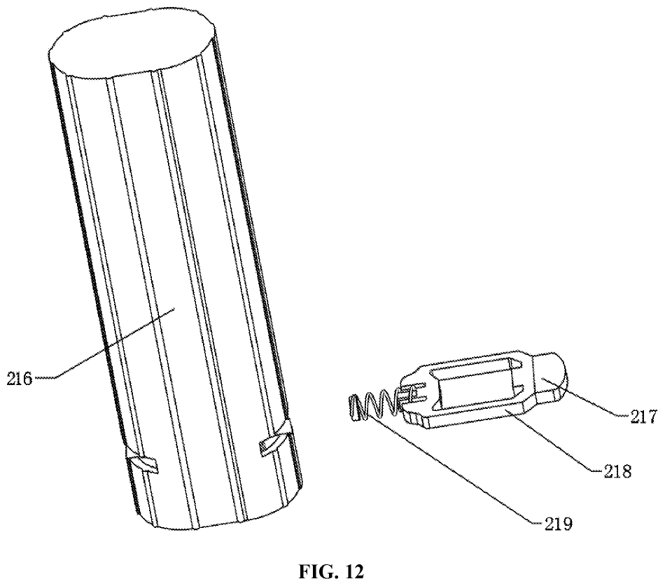

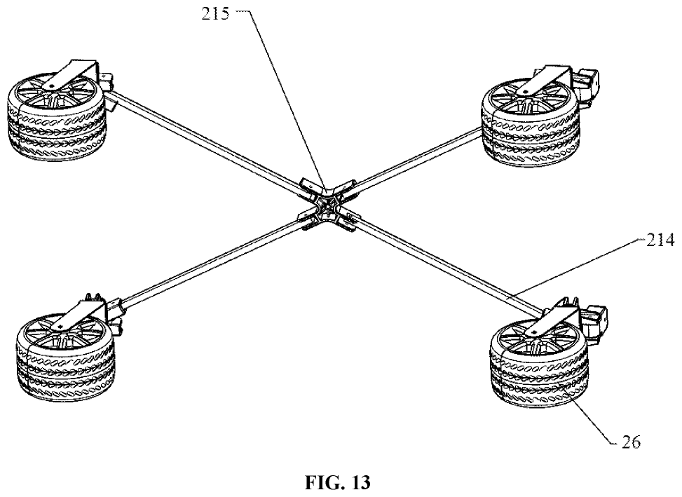

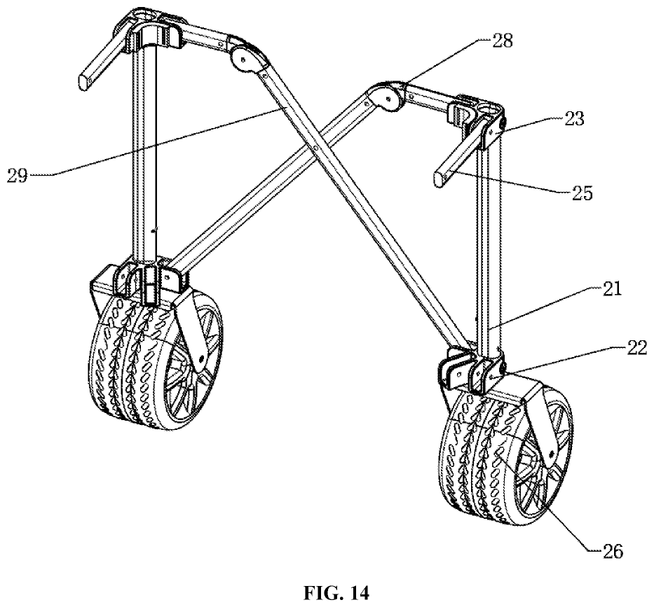

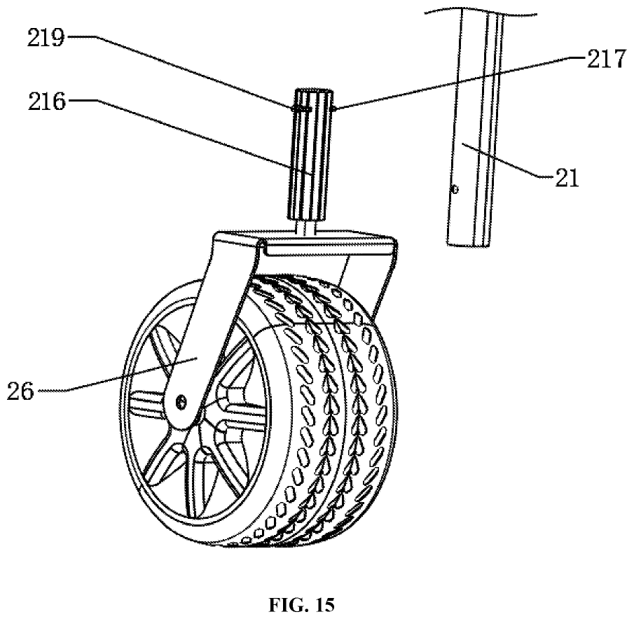

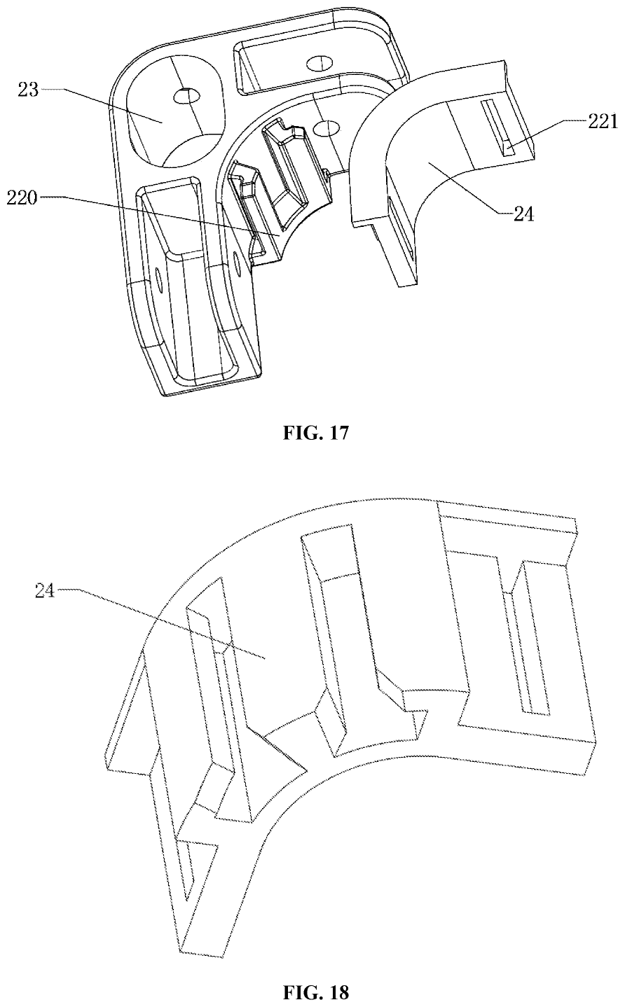

As shown in FIG. 11 to FIG. 18, a foldable all terrain vehicle provided in the embodiment includes a plurality of upright rods 21. Number of the upright rods 21 is four. The upright rods 21 are divided into groups, each of which is consisted of two upright rods. First connectors 27 are mounted at bottoms of two upright rods 21. Seventh connectors 22 are mounted at bottoms of another two upright rods 21. Bottom rods 214 are rotatably mounted on both the first connectors 27 and the seventh connectors 22 through first rotation shafts. An end of each of the bottom rods 214 is rotatably connected with an eighth connector 215 through a second rotation shaft. Fourth connectors 23 are mounted on the tops of the upright rods 21. A sixth connecting rod 25 is rotatably mounted at an end of each fourth connector 23. A third connecting rod 28 is rotatably mounted at the other end of the fourth connecting rod 23 through a third rotation shaft. Fourth connecting rods 29 are rotatably mounted on the third connecting rods 28 through fourth rotation shafts. One ends of the fourth connecting rods 29 are rotatably connected with the first connectors 27 or the seventh connectors 22 through fifth rotation shafts. Every two adjacent fourth connecting rods 29 are crossed and rotatably connected to each other through a sixth rotation shaft. First crosses are mounted on the sixth connecting rods 25. Every two adjacent first crosses are connected through a second cross. Second connectors 210 are rotatably mounted on the first connectors 27 through seventh rotation shafts. First connecting rods 211 are rotatably mounted on the second connectors 210 through eighth rotation shafts. A third connector 212 is rotatably connected with one ends of the first connecting rods 211 with through ninth rotation shafts. Each of the first crosses includes a third diagonal rod 224 and a second diagonal rod 223. The third diagonal rod 224 and the second diagonal rod 223 are rotatably connected through a tenth rotation shaft. One ends of the third diagonal rods 224 are rotatably connected with the sixth connecting rods 25 through eleventh rotation shafts. Another ends of the third diagonal rods 224 are rotatably connected with ones end of another group of third diagonal rods 224 through twelveth rotation shafts. One ends of one group of second diagonal rods 223 of the first crosses are rotatably connected with the first connectors 27 through thirteenth rotation shafts. One ends of another group of second diagonal rods 223 of the first crosses are rotatably connected with the seventh connectors 22 through fourteenth rotation shafts. Each of the second crosses includes two first diagonal rods 222 that are crossed and rotatably connected to each other through a fifteenth rotation shaft. One ends of the first diagonal rods 222 are rotatably connected with one ends of the second diagonal rods 223 through sixteenth rotation shafts. Another ends of the first diagonal rods 222 are rotatably connected with the third diagonal rods 224 through seventeenth rotation shafts. By arranging structures of the first crosses and structures of the second crosses to cooperate with each other, both sides of a cloth pocket can be supported at multiple points. Compared with crossed support of two steel tubes in the prior art, the support is more stable and is higher in stability. Moreover, the multi-point support of a side frame to the cloth pocket is beneficial for the cloth pocket to bear more weight, and the cloth pocket is not easily damaged due to excessive local load.

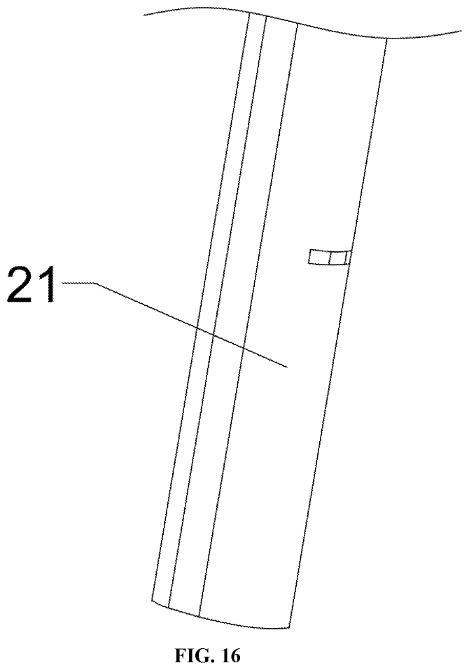

In this embodiment, as shown in FIG. 12, FIG. 15 and FIG. 16, insertion rods 216 are mounted on movable wheels 26. Latch mechanisms are mounted on the insertion rods 216. Slots matched with the insertion rods 216 are formed in the upright rods 21. The movable wheels 26 can be mounted by arranging the insertion rods 216 to be in snap-fit connection with the slots, and the mounted movable wheels 26 can be limited by the latch mechanisms. Each of the latch mechanisms includes a spring 219, a connecting plate 218 and a locking block 217. A sliding cavity adapted to the connecting plate 218 is formed in each insertion rod 216. The locking block 217 is mounted at one end of the connecting plate 218. The spring 219 is arranged at the other end of the connecting plate 218. A locking hole adapted to the locking block 217 is formed in each upright rod 21. A mounting hole adapted to the spring 219 is formed in each upright rod 21. By arranging the sliding cavities, the connecting plates 218 and the locking blocks 217 slide into the sliding cavities. The locking hole is formed in one side of each upright rod 21, and the mounting hole is formed in another side of each upright rod 21. The mounting holes are located below the locking holes. The insertion rods 216 are inserted into the slots. The springs 219 are inserted into the mounting holes to be connected with the connecting plates 218. The insertion rods 216 slide upwards. When the locking blocks 217 are aligned with the locking holes, the springs 219 extend. The locking blocks 217 are inserted into the locking holes to limit the insertion rods 216 so as to limit the mounted movable wheels 26.

In this embodiment, as shown in FIG. 11, mounting blocks 24 are slidably mounted on the fourth connectors 23, and connecting slots 221 are formed in both sides of each mounting block 24. Sliding blocks 220 are mounted on the fourth connectors 23, and sliding grooves matched with the sliding blocks 220 are formed in the mounting blocks 24. Number of the connecting slots 221 is two, and the two connecting slots 221 are symmetrically formed in both sides of the mounting block 24. By arranging the connecting slots 221, a cloth belt on the cloth pocket passes through the two connecting slots 221. The mounting blocks 24 are mounted on the cloth pocket. By arranging the sliding blocks 220 to be slidably connected with the sliding grooves, the mounting blocks 24 can be mounted, thus the cloth pocket can be mounted. The sliding blocks 220 are slidably connected with the sliding grooves, so that positions of the mounting blocks 24 can be limited, thus position of the cloth pocket can be limited. A handle 213 is mounted on the third connector 212. By arranging the handle 213, the all terrain vehicle can be pushed.

In this embodiment, as shown in FIG. 11 to FIG. 18, working process of the all terrain vehicle provided in this embodiment is as follows.

In step 1, the cloth pocket is connected with the mounting blocks 24, the sliding grooves of the mounting blocks 24 slide on the sliding blocks 220 to mount the mounting blocks 24, thus the cloth pocket is mounted on the all terrain vehicle.

In step 2, the insertion rods 216 are inserted into the slots. The springs 219 are inserted into the mounting holes to be connected with the connecting plates 218. The insertion rods 216 slide upwards. When the locking blocks 217 are aligned with the locking holes, the springs 219 extend. The locking blocks 217 are clamped into the locking holes to limit the insertion rods 216, and the movable wheels 26 are mounted.

In conclusion, in the embodiment, according to the all terrain vehicle in this embodiment, by arranging the connecting slots 221, the cloth belt on the cloth pocket passes through the two connecting slots 221. The mounting blocks 24 are mounted on the cloth pocket. By arranging the sliding blocks 220 to be slidably connected with the sliding grooves, the mounting blocks 24 can be mounted, thus the cloth pocket can be mounted. The sliding blocks 220 are slidably connected with the sliding grooves, so that positions of the mounting blocks 24 can be limited, thus position of the cloth pocket can be limited. By arranging structures of the first crosses and structures of the second crosses to cooperate with each other, both sides of the cloth pocket can be supported at multiple points. Compared with crossed support of two steel tubes in the prior art, the support is more stable and is higher in stability. Moreover, the multi-point support of a side frame to the cloth pocket is beneficial for the cloth pocket to bear more weight, and the cloth pocket is not easily damaged due to excessive local load. The movable wheels 26 can be mounted by arranging the insertion rods 216 to be in snap-fit connection with the slots. The mounted movable wheels 26 can be limited by the latch mechanisms. The insertion rods 216 are inserted into the slots. The springs 219 are inserted into the mounting holes to be connected with the connecting plate 218 (here, it should be that the springs 219 are sleeved on the connecting plates 218). The insertion rods 216 slide upwards. When the locking blocks 217 are aligned with the locking holes, the springs 219 extend. The locking blocks 217 are inserted into the locking holes to limit the insertion rods 216 so as to limit the mounted movable wheels 26. By arranging the handle 213, the all terrain vehicle can be pushed.

Adaptive changes made according to actual requirements all fall within the protection scope of the present disclosure.

It needs to be noted that for those skilled in the art, it is apparent that the present disclosure is not limited to the details of the exemplary embodiment, and the present disclosure can be achieved in other specific forms without departing from the spirit or essential characteristics of the present disclosure. Therefore, for every point, the embodiments should be regarded as exemplary embodiments and are unrestrictive. The scope of the present disclosure is limited by the appended claims rather than the above description, and therefore, all changes, including the meanings and scopes of equivalent elements, of the claims are aimed to be included in the present disclosure. Any reference signs of attached figures in the claims should not be regarded as limitation to the involved claims.

What is claimed is:

1. A foldable all terrain vehicle, comprising a base support, seventh connectors, first connectors, movable wheels, X-shaped movable frames, upright rods, fifth connecting rods, and sixth connectors, wherein the base support comprises four bottom rods and an eighth connector, one end of each of the bottom rods is rotatably connected with the eighth connector, the bottom rods rotate downwards relative to the eighth connector, the seventh connectors are movably connected to outer ends of two bottom rods of the bottom rods, the first connectors are movably connected to outer ends of another two bottom rods of the bottom rods, the movable wheels are mounted at bottoms of the two first connectors, the X-shaped movable frames are connected to one sides of the seventh connectors, the upright rods are mounted on tops of the seventh connectors, the fifth connecting rods are rotatably mounted on another sides of the seventh connectors, and the X-shaped movable frames are slidably connected to the fifth connecting rods through the sixth connectors.

2. The foldable all terrain vehicle according to claim 1, wherein each of the X-shaped movable frames comprises two fourth connecting rods that are rotatably connected to each other, and bottom ends of the fourth connecting rods are rotatably connected to the seventh connectors.

3. The foldable all terrain vehicle according to claim 2, wherein the foldable all terrain vehicle further comprises fourth connectors, fifth connectors, and third connecting rods, the fourth connectors are mounted on tops of the upright rods, the third connecting rods are rotatably connected to top ends of the fourth connecting rods through the fifth connectors, the third connecting rods are rotatably connected with the fourth connectors, and top ends of the X-shaped movable frames are movably connected with the third connecting rods through the fifth connectors.

4. The foldable all terrain vehicle according to claim 3, wherein two opposite third connecting rods in the third connecting rods are same in length.

5. The foldable all terrain vehicle according to claim 1, wherein the foldable all terrain vehicle further comprises second connectors, and first connecting rods, the second connectors are movably mounted on tops of the first connectors, and the first connecting rods are rotatably connected to the second connectors; and the X-shaped movable frames are arranged between two first connectors in the first connectors.

6. The foldable all terrain vehicle according to claim 5, wherein the foldable all terrain vehicle further comprises a rotatable third connector, a second connecting rod, and a handle, the third connector is connected to top ends of two first connecting rods in the first connecting rods, the second connecting rod is inserted and connected to the third connector, and the handle is mounted on a top of the second connecting rod.

7. The foldable all terrain vehicle according to claim 2, wherein anti-skid grooves are formed in wheel surfaces of the movable wheels.

8. The foldable all terrain vehicle according to claim 1, wherein the eighth connector is in an X-shape, and four ends of the eighth connector are rotatably connected with one ends of the bottom rods through screws, respectively.

9. The foldable all terrain vehicle according to claim 5, wherein bottom ends of the second connectors are rotatably connected with the first connectors, and notches for placing rotating cylinders of the second connectors are formed in the first connectors.

10. The foldable all terrain vehicle according to claim 3, wherein the fourth connecting rods and the third connecting rods are connected through the fifth connectors, and each of the fifth connectors comprises two sleeves that are rotatably connected to each other.

11. A foldable all terrain vehicle, comprising a plurality of upright rods, first connectors, seventh connectors, a plurality of bottom rods, an eighth connector, fourth connectors, sixth connecting rods, third connecting rods, fourth connecting rods, first crosses, second crosses, second connectors, first connecting rods, and a third connector, wherein number of the plurality of upright rods is four, the plurality of upright rods are divided into groups, each group is consisted of two upright rods in the plurality of upright rods, the first connectors are mounted at bottoms of two upright rods in the plurality of upright rods, the seventh connectors are mounted at bottoms of another two upright rods in the plurality of upright rods, the plurality of bottom rods are rotatably mounted on both the first connectors and the seventh connectors, the eighth connector is rotatably connected to one end of each bottom rod of the plurality of bottom rods, the fourth connectors are rotatably mounted on tops of the plurality of upright rods, the sixth connecting rods are rotatably mounted at one ends of the fourth connectors, the third connecting rods are rotatably mounted at another ends of the fourth connecting rods, the fourth connecting rods are rotatably mounted on the third connecting rods, one ends of the fourth connecting rods are rotatably connected with the first connectors and the seventh connectors, every two adjacent fourth connecting rods in the fourth connecting rods are crossed and rotatably connected to each other, the first crosses are mounted on the sixth connecting rods, every two adjacent first crosses in the first crosses are connected through a second cross of the second crosses, the second connectors are rotatably mounted on the first connectors, the first connecting rods are rotatably mounted on the second connectors, the third connector is rotatably connected to one ends of he first connecting rods, each of the first crosses comprises a third diagonal rod and a second diagonal rod, the third diagonal rod is rotatably connected with the second diagonal rod, one end of the third diagonal rod is rotatably connected with one of the sixth connecting rods, another end of the third diagonal rod is rotatably connected with one end of the third diagonal rod of another first cross in the first crosses, one end of the second diagonal rod of a first cross in the first crosses is rotatably connected with one of the first connectors, one end of the second diagonal rod of another first cross in the first crosses is rotatably connected with one of the seventh connectors, each of the second crosses comprises two first diagonal rods that are crossed and rotatably connected to each other, one end of each of the first diagonal rods is rotatably connected with one end of the second diagonal rod, and another end of each of the first diagonal rods is rotatably connected with the third diagonal rod.

12. The foldable all terrain vehicle according to claim 11, wherein mounting blocks are slidably mounted on the fourth connectors, and connecting slots are formed in both sides of each of the mounting blocks.

13. The foldable all terrain vehicle according to claim 12, wherein sliding blocks are mounted on the fourth connectors, and sliding grooves matched with the sliding blocks are formed in the mounting blocks.

14. The foldable all terrain vehicle according to claim 12, wherein number of the connecting slots is two, and the two connecting slots are symmetrically formed in both sides of each of the mounting blocks.

15. The foldable all terrain vehicle according to claim 11, wherein the foldable all terrain vehicle further comprises movable wheels, insertion rods are mounted on the movable wheels, latch mechanisms are mounted on the insertion rods, and slots matched with the insertion rods are formed in the upright rods.

16. The foldable all terrain vehicle according to claim 15, wherein each of the latch mechanisms comprises a spring, a connecting plate, and a locking block, a sliding cavity adapted to the connecting plate is formed in each of the insertion rods, the locking block is mounted at one end of the connecting plate, the spring is arranged at another end of the connecting plate, a locking hole adapted to the locking block is formed in each of the upright rods, and a mounting hole adapted to the spring is formed in each of the upright rods.

17. The foldable all terrain vehicle according to claim 16, wherein the locking hole is formed in one side of each of the upright rods, the mounting hole is formed in another side of each of the upright rods, and the mounting hole is located below the locking hole.

18. The foldable all terrain vehicle according to claim 11, wherein a handle is mounted on the third connector.
